(19) United States
(12) Patent Application Publication
(10) Pub. No.: US 2015/0361000 A1
(43) Pub. Date: Dec. 17, 2015

(54) METHOD AND APPARATUS FOR MANUFACTURING GLASS STRUCTURE

(71) Applicants: CREATING NANO TECHNOLOGIES, INC., Tainan City (TW); Key Application Technology Co., Ltd., Hsinchu County (TW)

(72) Inventors: Yih-Ming SHYU, TAINAN CITY (TW); Yen-Ling LIU, TAINAN CITY (TW); Chien-Jen HSIAO, Hsinchu County (TW)

(21) Appl. No.: 14/517,937

(22) Filed: Oct. 20, 2014

(30) Foreign Application Priority Data
Jun. 11, 2014 (TW) 103120189

(51) Int. Cl. C03C 23/00; C03C 17/00; C03C 17/22

(52) U.S. Cl. CPC C03C 23/0025; C03C 23/006; C03C 17/22; C03C 17/001; C03C 23/007

(57) ABSTRACT

A method and an apparatus for manufacturing a glass structure are described, which includes the following steps. A glass substrate is provided. A ceramic precursor layer is formed to cover a surface of the glass substrate. A laser annealing treatment is performed on the ceramic precursor layer to crystallize the ceramic precursor layer into a ceramic film.

### RELATED APPLICATIONS

This application claims priority to Taiwan Application Serial Number 103120189, filed Jun. 11, 2014, which is herein incorporated by reference.

### BACKGROUND

1. Field of Invention

The present invention relates to a glass treatment technique. More particularly, the present invention relates to a method and an apparatus for manufacturing a glass structure.

2. Description of Related Art

As touch screen electronic products are rising and developing, requirements for hardness and abrasion resistance of touch screens are increasingly stringent. Currently, in order to increase the hardness and the abrasion resistance of the touch screens, some touch screen products adopt sapphire to replace glass as protective covers of the touch screens.

Using the sapphire as the protective cover of the touch screen can effectively increase the hardness and the abrasion resistance of the touch screen, but a sapphire substrate is expansive, and thus cost of the touch screen is increased. In addition, a surface of the sapphire substrate is inerter, so that subsequent processes, such as a printing process and a coating process, are more difficult, thereby increasing process cost. Thus, adopting the sapphire substrate as the protective cover of the touch screen greatly increases cost, and process yield is poor due to high difficulty of the process.

### SUMMARY

Therefore, one objective of the present invention is to provide a method and an apparatus for manufacturing a glass structure, which coats a ceramic precursor layer on a surface of a glass substrate, and performs a laser annealing treatment on the ceramic precursor layer to crystallize the ceramic precursor layer into a ceramic film, so that surface hardness of the glass structure is effectively increased.

Another objective of the present invention is to provide a method and an apparatus for manufacturing a glass structure, which can clean a surface of a glass substrate using plasma, and then coat a ceramic precursor layer on the surface of the glass substrate, so that ceramic precursors of the ceramic precursor layer can infiltrate into capillary pores of the surface of the glass substrate to increase a connection area between a ceramic film formed by crystallizing the ceramic precursor layer and the surface of the glass substrate, thereby increasing adhesive force of the ceramic film to the surface of the glass substrate. Thus, surface strength of the glass structure can be enhanced.

Still another objective of the present invention is to provide a method and an apparatus for manufacturing a glass structure, which can effectively enhance surface strength of the glass structure, so that the glass structure can be used as a protective cover of a touch screen. Therefore, difficulty of a process for fabricating the touch screen can be greatly reduced, and process yield can be increased, thereby decreasing cost of the substrate and the process.

According to the aforementioned objectives, the present invention provides a method for manufacturing a glass structure, which includes the following steps. A glass substrate is provided. A ceramic precursor layer is formed to cover a surface of the glass substrate. A laser annealing treatment is performed on the ceramic precursor layer to crystallize the ceramic precursor layer into a ceramic film.

According to one embodiment of the present invention, the method for manufacturing the glass structure further includes performing a plasma treatment on the surface of the glass substrate to clean capillary pores of the surface of the glass substrate before the ceramic precursor layer is coated on the surface of the glass substrate.

According to another embodiment of the present invention, the operation of forming the ceramic precursor layer includes infiltrating the ceramic precursor layer into the capillary pores.

According to still another embodiment of the present invention, the operation of forming the ceramic precursor layer is performed using a spray coating method, a dip coating method or an inkjet printing method.

According to further another embodiment of the present invention, the operation of forming the ceramic precursor layer includes forming the ceramic precursor layer from metal, metal oxide, metal oxycarbide, metal carbide and/or a mixture thereof.

According to yet another embodiment of the present invention, the operation of forming the ceramic precursor layer is performed to form the ceramic precursor layer including a major component and a minor component, in which the major component includes silicon oxide, aluminum oxide, calcium oxide and/or magnesium oxide, and the minor component includes iron, titanium, manganese, lead or a rare earth element.

According to still further another embodiment of the present invention, the operation of forming the ceramic precursor layer includes performing operations, each of the operation is performed to form a dense ceramic precursor film, and each of the operation of forming the dense ceramic precursor film includes forming a ceramic precursor film and performing a pre-baking treatment on the ceramic precursor film to form the dense ceramic precursor film.

According to the aforementioned objectives, the present invention further provides an apparatus for manufacturing a glass structure. The apparatus for manufacturing the glass structure includes a conveyer, a coating device, and a laser annealing device. The conveyer is suitable to convey a glass substrate. The coating device is disposed above the conveyer and is suitable to form a ceramic precursor layer on a surface of the glass substrate. The laser annealing device is disposed above the conveyer and is suitable to perform a laser annealing treatment on the ceramic precursor layer on the surface of the glass substrate.

According to one embodiment of the present invention, the apparatus for manufacturing the glass structure further includes a plasma device. The plasma device is disposed above the conveyer and is suitable to perform a plasma treatment on the surface of the glass substrate before the ceramic precursor layer is coated on the surface of the glass substrate.

According to another embodiment of the present invention, the coating device includes a coating unit and a baking unit. The coating unit is suitable to coat a ceramic precursor film on the surface of the glass substrate. The baking unit is suitable to perform a pre-baking treatment on the ceramic precursor film.

### BRIEF DESCRIPTION OF THE DRAWINGS

The invention can be more fully understood by reading the following detailed description of the embodiment, with reference made to the accompanying drawings as follows.

FIG. 1 is a schematic diagram showing an apparatus for manufacturing a glass structure in accordance with one embodiment of the present invention;

FIG. 2A through FIG. 2D are schematic cross-sectional views of intermediate stages showing a method for manufacturing a glass structure in accordance with one embodiment of the present invention; and

FIG. 3A through FIG. 3G are schematic cross-sectional views of intermediate stages showing a method for manufacturing a glass structure in accordance with another embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

In view of hardness and abrasion resistance of a surface of a typical glass have not satisfied requirements of a touch screen of today, and the difficulty of fabricating the touch screen is rose and the cost is greatly increased with the use of a sapphire substrate. Thus, embodiments of the present disclosure provide a method and an apparatus for manufacturing a glass structure, which can manufacture a glass structure having hardness and abrasion resistance satisfying the requirements of the touch screen without increasing difficulty of process practice and cost.

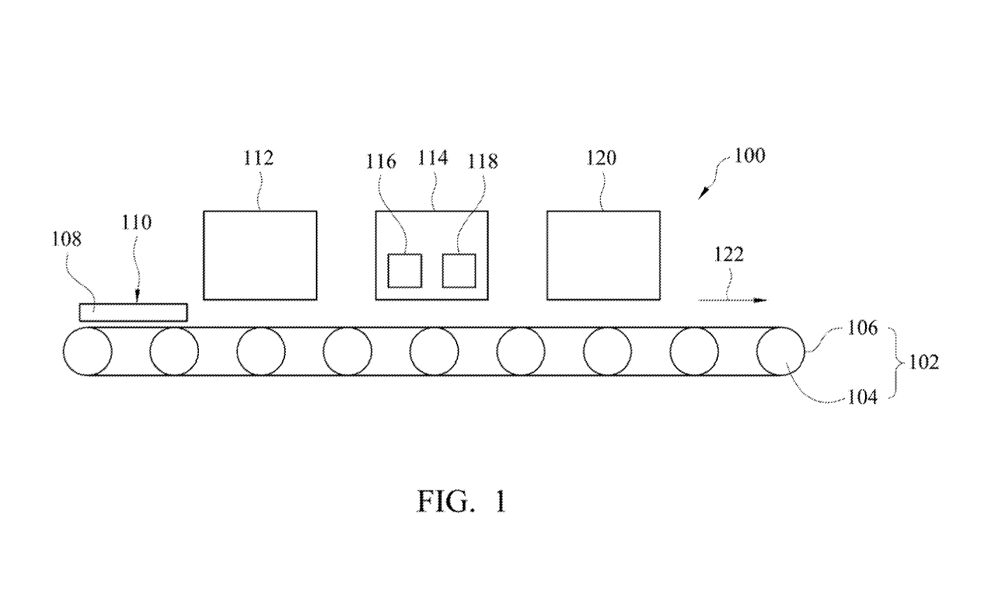

FIG. 1 is a schematic diagram showing an apparatus for manufacturing a glass structure in accordance with one embodiment of the present invention. In the present embodiment, an apparatus 100 for manufacturing a glass structure mainly includes a conveyer 102, a coating device 114 and a laser annealing device 120. The conveyer 102 is suitable to convey one or more glass substrates 108 used to manufacture glass structures to move the glass substrates 108 along a direction 122. The conveyer 102 may include a conveyer belt 106 and several rollers 104. In some examples, the conveyer 102 may only include one conveyer belt 106 without the rollers 104. In certain examples, the conveyer 102 may only include several rollers 104 without the conveyer belt 106. The conveyer 102 is a continuous drive mechanism or an inching drive mechanism.

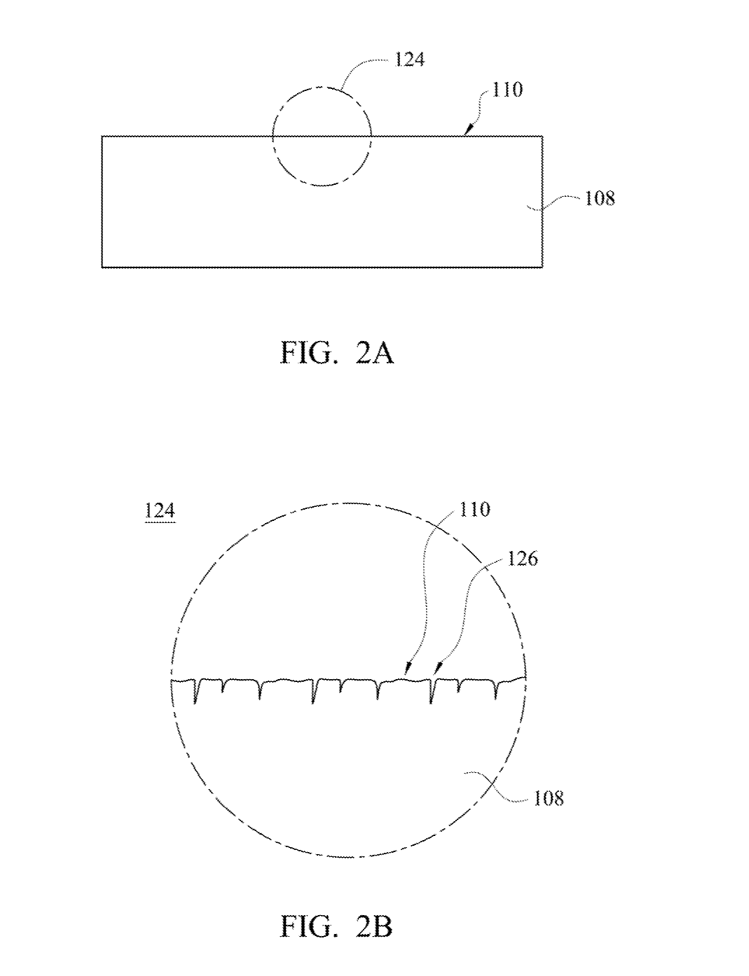

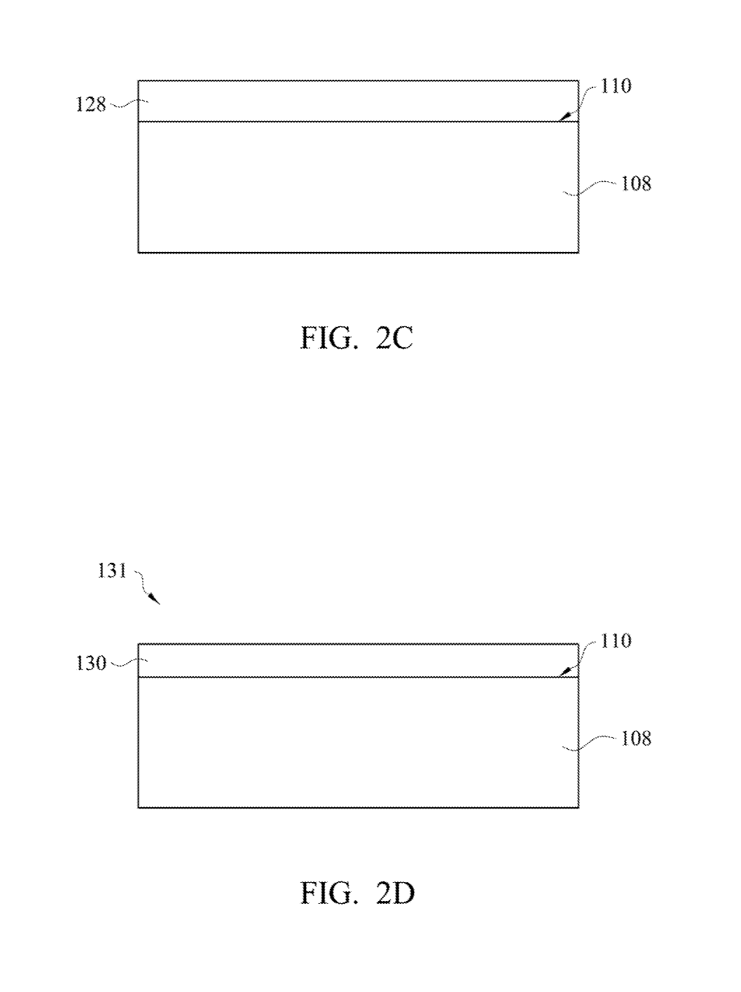

The coating device 114 is disposed above the conveyer 102. When the glass substrate 108 is conveyed by the conveyer 102 to which beneath the coating device 114, a ceramic precursor layer 128 (referring to FIG. 2C) is formed on a surface 110 of the glass substrate 108 by using the coating device 114. When the conveyer 102 is an inching drive mechanism, the conveyer 102 moves forward with a constant stepping distance, then stops for a predetermined period and continues stepping forward, so that the usage amount of ceramic precursors can be decreased. In some examples, as shown in FIG. 1, the coating device 114 includes a coating unit 116 and a baking unit 118. The coating unit 116 may be used to coat a ceramic precursor film on the surface 110 of the glass substrate 108. The baking unit 118 is disposed after the coating unit 116 to perform a pre-baking treatment on the ceramic precursor film coated on the surface 110 of the glass substrate 108, so as to densify the ceramic precursor film. In certain examples, the coating device 114 may include various coating units 116 and various baking units 118, in which the coating units 116 and the baking units 118 are alternately arranged along the direction 122 to alternatively perform various ceramic precursor film coating treatments and pre-baking treatments on the surface 110 of the glass substrate 108.

In some exemplary embodiments, the apparatus 100 for manufacturing the glass structure further includes a plasma device 112. The plasma device 112 is disposed above the conveyer 102 and before the coating device 114. The plasma device 112 can be used to perform a plasma treatment on the surface 110 of the glass substrate 108 to clean and/or activate the surface 110 of the glass substrate 108 before the ceramic precursor layer 128 (referring to FIG. 2C) is coated on the surface 110 of the glass substrate 108 by the coating device 114. In some examples, the plasma treatment performed on the surface 110 of the glass substrate 108 by the plasma device 112 can clean capillary pores of the surface 110. In addition, reactive gas used by the plasma device 112 may be air, nitrogen, argon or helium; or, nitrogen, argon or helium mixing with a small quantity of air, oxygen or hydrogen. In some exemplary examples, the plasma device 112 may be an atmospheric plasma device, and may include a plasma jet array source, a rotary type plasma jet source, a dielectric barrier discharge (DBD) plasma source or a radio frequency (RF) plasma source.

The laser annealing device 120 is similarly disposed above the conveyer 102, but is located after the coating device 114. The laser annealing device 120 may be used to perform a laser annealing treatment on the ceramic precursor layer 128 on the surface 110 of the glass substrate 108 to crystallize the ceramic precursor layer 128 into a ceramic film 130 (referring to FIG. 2D).

In one embodiment of the present invention, a method for manufacturing a glass structure can be practiced by using the apparatus 100 for manufacturing the glass structure. Simultaneously referring to FIG. 1 and FIG. 2A through FIG. 2D. FIG. 2A through FIG. 2D are schematic cross-sectional views of intermediate stages showing a method for manufacturing a glass structure in accordance with one embodiment of the present invention, in the present embodiment, in the manufacturing of a glass structure 131 as shown in FIG. 2D, a glass substrate 108 as shown in FIG. 2A is firstly provided, and the glass substrate 108 is disposed on a transport device, such as a conveyer 102 of the apparatus 100 shown in FIG. 1. The conveyer 102 can convey the glass substrates 108 forward along a direction 122.

In some examples, when the glass substrate 108 is conveyed by the conveyer 102 to which beneath the coating device 114, a ceramic precursor layer 128 is formed on a surface 110 of the glass substrate 108 by using the coating device 114 directly, as shown in FIG. 2C. In the examples, referring to FIG. 1 again, a ceramic precursor film may be firstly coated on the surface 110 of the glass substrate 108 by a coating unit 116 of the coating device 114 using a spray coating method or an inkjet printing method, and the ceramic precursor film is pre-baked by a baking unit 118 of the coating device 114 to densify the ceramic precursor film, so as to form the ceramic precursor layer 128. In some certain examples, a ceramic precursor film may be firstly coated on the surface 110 of the glass substrate 108 by using a dip coating method, and the ceramic precursor film is pre-baked by similarly using the baking unit 118 to densify the ceramic precursor film, so as to form the ceramic precursor layer 128. In some exemplary examples, a temperature of the pre-baking treatment performed on the ceramic precursor film may be controlled in a range from 100 degrees centigrade to 400 degrees centigrade.

The ceramic precursor layer 128 may be formed from metal, metal oxide, metal oxycarbide, metal carbide and/or any mixture of the aforementioned compositions. The mixtures may be liquid-phase mixtures or solutions. In some exemplary examples, the ceramic precursor layer 128 may include a major component and a minor component, i.e. the ceramic precursor layer 128 includes the major component with a larger content and the minor component with a smaller content. The major component includes silicon oxide, aluminum oxide, calcium oxide and/or magnesium oxide, and the minor component includes iron, titanium, manganese, lead or a rare earth element.

In some examples, as shown in an enlarged portion 124 of FIG. 28, the surface 110 of the glass substrate 108 has a lot of capillary pores 126. Therefore, before the ceramic precursor layer 128 is coated on the surface 110 of the glass substrate 108, i.e. the glass substrate 108 is conveyed to which beneath the plasma device 112 before the coating device 114 by the conveyer 102, a plasma treatment is firstly performed on the surface 110 of the glass substrate 108 by using the plasma device 112 to clean and/or activate the surface 110 of the glass substrate 108. In the plasma treatment, contaminants within the capillary pores 126 of the surface 110 of the glass substrate 108 can be cleaned away. In addition, the plasma treatment may be performed to form special functional groups on the surface 110 of the glass substrate 108 so as to activate the surface 110 of the glass substrate 108 to facilitate the ceramic precursor layer 128 coated subsequently to connect with the surface 110 more closely. In one exemplary example, reactive gas used by the plasma device 112 may be air, nitrogen, argon or helium; or, nitrogen, argon or helium mixing with a small quantity of air, oxygen or hydrogen.

In the examples, the capillary pores 126 of the surface 110 of the glass substrate 108 are cleaned before the ceramic precursor layer 128 is coated, so that when the ceramic precursor layer 128 is coated, the ceramic precursor layer 128 infiltrates into the capillary pores 126. Thus, a connection area between the ceramic precursor layer 128 and the surface 110 of the glass substrate 108 is increased to enhance adhesive force of the ceramic precursor layer 128 to the surface 110 of the glass substrate 108.

After the ceramic precursor layer 128 is coated, as shown in FIG. 1, the glass substrate 108 is continuously conveyed forward to which beneath the laser annealing device 120 by the conveyer 102 along the direction 122. A laser annealing treatment is performed on the ceramic precursor layer 128 on the surface 110 of the glass substrate 108 using the laser annealing device 120 to crystallize the ceramic precursor layer 128 into a ceramic film 130 using energy provided by the laser. In some exemplary examples, power of the laser annealing treatment may be controlled in a range from 50 mj/cm² to 800 mj/cm². Presently, as shown in FIG. 2D, a glass structure 131 including the glass substrate 108 and the ceramic film 130 stacked on the glass substrate 108 is completed.

It can form the glass structure 131 having a surface of very high hardness and abrasion resistance by coating the ceramic precursor layer 128 on the surface 110 of the glass substrate 108 and using the laser annealing treatment to crystallize the ceramic precursor layer 128 to form the ceramic film 130. In addition, the ceramic precursor layer 128 infiltrates into the capillary pores 126 of the surface 110 of the glass substrate 108, so that the ceramic film 130 formed by crystallizing the ceramic precursor layer 128 is embedded into the capillary pores 126 of the surface 110. Thus, adhesive force of the ceramic film 130 to the surface 110 is increased, thereby enhancing surface strength of the glass structure 131. The hardness and the abrasion resistance of the surface of the glass structure 131 are high, so that the glass structure 131 can be applied to fabricate a protective cover of a touch screen, and the objectives of reducing difficulty of a process for fabricating the touch screen, increasing process yield, and decreasing cost of the substrate and the process can be achieved.

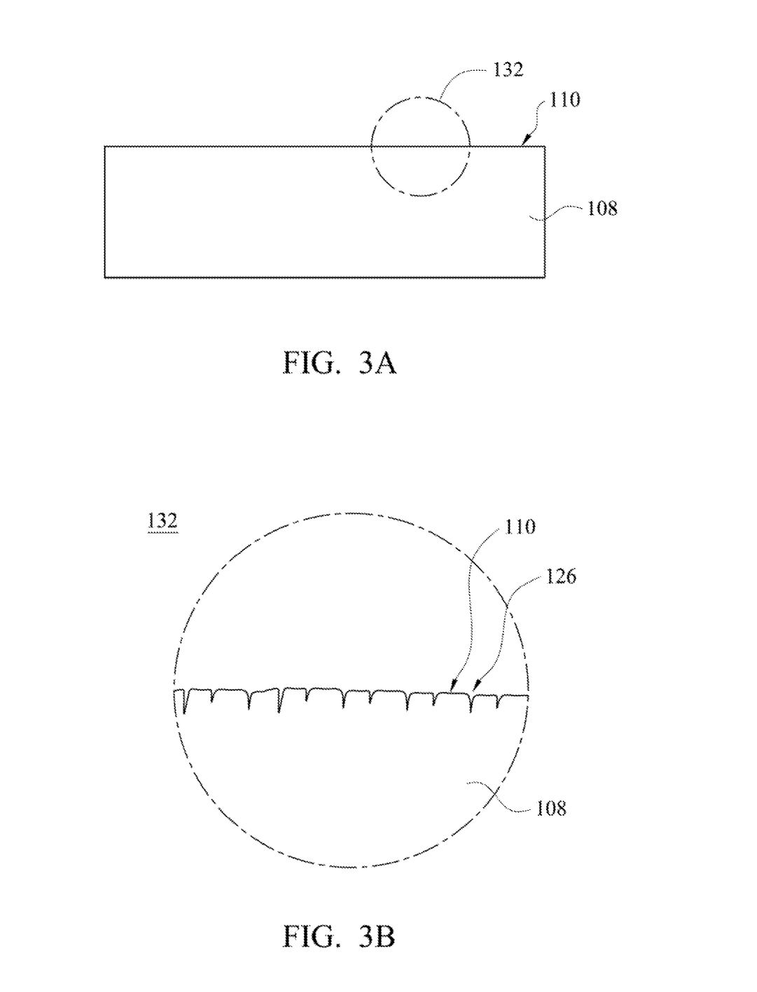

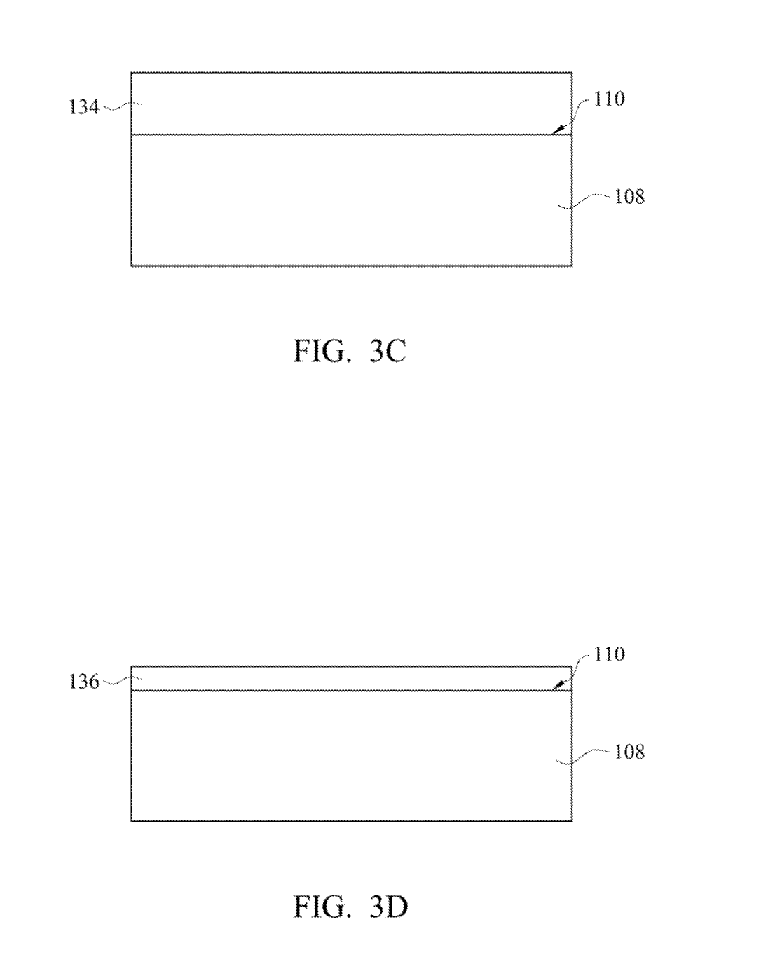

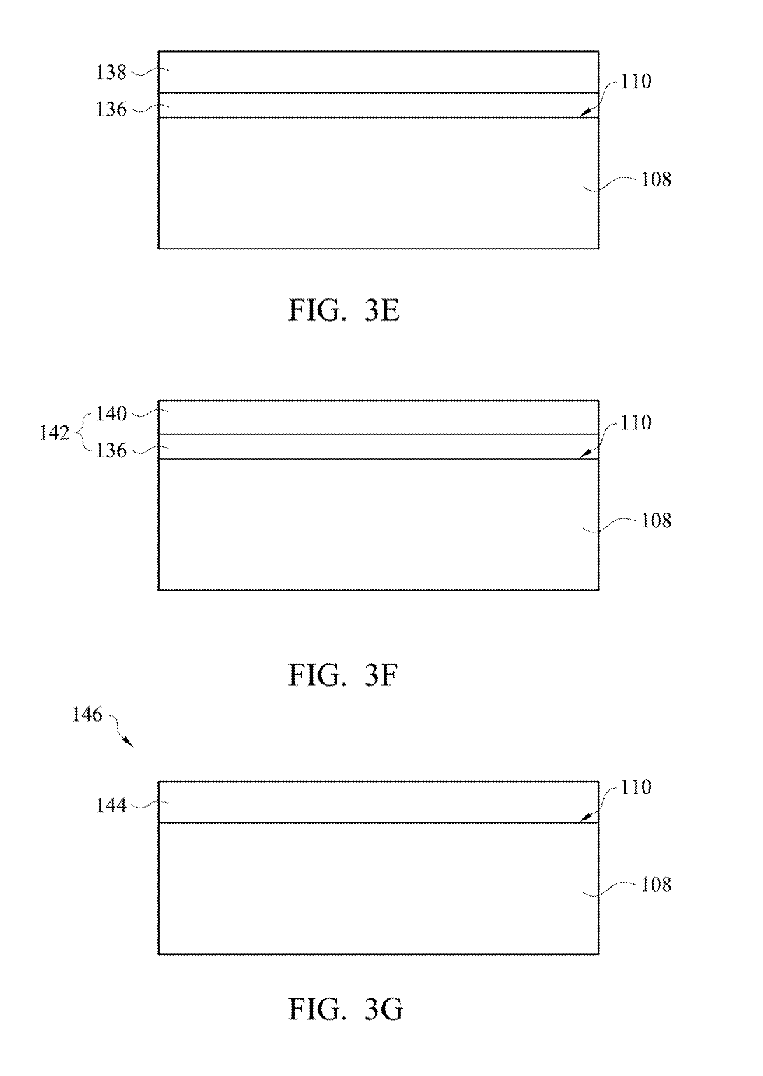

Simultaneously referring to FIG. 1 and FIG. 3A through FIG. 3G. FIG. 3A through FIG. 3G are schematic cross-sectional views of intermediate stages showing a method for manufacturing a glass structure in accordance with another embodiment of the present invention. In the present embodiment, in the manufacturing of a glass structure 146 as shown in FIG. 3G, a glass substrate 108 as shown in FIG. 2A and FIG. 3A is firstly provided, and the glass substrate 108 is disposed on a transport device, such as a conveyer 102 of the apparatus 100 shown in FIG. 1. The conveyer 102 can convey the glass substrates 108 forward along a direction 122.

In some exemplary embodiments, as shown in an enlarged portion 132 of FIG. 3B, the surface 110 of the glass substrate 108 has a lot of capillary pores 126. Therefore, before a coating operation is performed on the surface 110 of the glass substrate 108, the glass substrate 108 is conveyed to which beneath the plasma device 112 before the coating device 114 by the conveyer 102, and a plasma treatment is firstly performed on the surface 110 of the glass substrate 108 by using the plasma device 112 to clean and/or activate the surface 110 of the glass substrate 108. In the plasma treatment, contaminants within the capillary pores 126 of the surface 110 of the glass substrate 108 can be cleaned away, and special functional groups are formed on the surface 110 of the glass substrate 108 to activate the surface 110 of the glass substrate 108 to facilitate the ceramic precursor film 134 (referring to FIG. 3C) coated subsequently to connect with the surface 110 more closely. In one exemplary example, reactive gas used by the plasma device 112 may be air, nitrogen, argon or helium; or, nitrogen, argon or helium mixing with a small quantity of air, oxygen or hydrogen.

In some exemplary embodiments, the plasma treatment procedure can be omitted, and the coating of the ceramic precursors is directly performed. In the exemplary embodiments, when the glass substrate 108 is conveyed by the conveyer 102 to which beneath the coating device 114, the surface 110 of the glass substrate 108 is coated by using the coating device 114 directly. In the embodiment, various ceramic precursor film coating treatments and pre-baking treatments are alternatively performed on the surface 110 of the glass substrate 108. Referring to FIG. 1 again, a ceramic precursor film 134 is firstly coated on the surface 110 of the glass substrate 108 by a coating unit 116 of the coating device 114 using a spray coating method or an inkjet printing method, as shown in FIG. 3C. Then, the ceramic precursor film 134 is pre-baked by a baking unit 118 of the coating device 114 to densify the ceramic precursor film 134, so as to form a dense ceramic precursor layer 136, as shown in FIG. 3D.

Subsequently, as shown in FIG. 3E, another ceramic precursor film 138 is coated on the dense ceramic precursor layer 136 by using the coating unit 116 again. Then, the ceramic precursor film 138 is pre-baked by the baking unit 118 to densify the ceramic precursor film 138, so as to form a dense ceramic precursor layer 140. Thus, as sown in FIG. 3F, a ceramic precursor layer 142 composed of the dense ceramic precursor films 136 and 140 stacked with each other is formed on the surface 110 of the glass substrate 108. The exemplary embodiments uses a process of forming two dense ceramic precursor films 136 and 140 for illustration, however, the step of forming a ceramic precursor layer of the present embodiment may include more than two steps of forming one dense ceramic precursor film, and each step of forming one dense ceramic precursor film includes a step of coating a ceramic precursor film and a pre-baking step.

In some exemplary examples, a temperature of the pre-baking treatment performed on the ceramic precursor films 134 and 138 may be controlled in a range from 100 degrees centigrade to 400 degrees centigrade. Furthermore, in addition to a spray coating method or an inkjet printing method, a dip coating method may be used to coat the ceramic precursor films 134 and 138.

Similarly, the ceramic precursor layer 142 may be formed from metal, metal oxide, metal oxycarbide, metal carbide and/or any mixture of the aforementioned compositions. The mixtures may be liquid-phase mixtures or solutions. In some exemplary examples, the ceramic precursor layer 142 may include a major component and a minor component, i.e. the ceramic precursor layer 142 includes the major component with a larger content and the minor component with a smaller content. The major component includes silicon oxide, aluminum oxide, calcium oxide and/or magnesium oxide, and the minor component includes iron, titanium, manganese, lead or a rare earth element.

The capillary pores 126 of the surface 110 of the glass substrate 108 are cleaned before the ceramic precursor layer 142 is coated, so that when the ceramic precursor film 134 is coated, the ceramic precursor film 134 infiltrates into the capillary pores 126. Thus, a connection area between the ceramic precursor film 134 and the surface 110 of the glass substrate 108 is increased to enhance adhesive force of the ceramic precursor film 134 to the surface 110 of the glass substrate 108.

After the ceramic precursor layer 128 is coated, as shown in FIG. 1, the glass substrate 108 is continuously conveyed forward to which beneath the laser annealing device 120 by the conveyer 102 along the direction 122. A laser annealing treatment is performed on the ceramic precursor layer 142 on the surface 110 of the glass substrate 108 using the laser annealing device 120 to crystallize the ceramic precursor layer 142 into a ceramic film 144 using energy provided by the laser. In some exemplary examples, power of the laser annealing treatment may be controlled in a range from 50 mj/cm² to 800 mj/cm² Presently, as shown in FIG. 3G, a glass structure 146 including the glass substrate 108 and the ceramic film 144 stacked on the glass substrate 108 is completed.

According to the aforementioned embodiments, one advantage of the present invention is that a ceramic precursor layer is firstly coated on a surface of a glass substrate, and a laser annealing treatment is performed on the ceramic precursor layer to crystallize the ceramic precursor layer into a ceramic film, so that surface hardness of the glass structure is effectively increased.

According to the aforementioned embodiments, another advantage of the present invention is that a surface of a glass substrate can be cleaned using plasma, and then a ceramic precursor layer is coated on the surface of the glass substrate, so that ceramic precursors of the ceramic precursor layer can easily infiltrate into capillary pores of the surface of the glass substrate to increase a connection area between a ceramic film formed by crystallizing the ceramic precursor layer and the surface of the glass substrate, thereby increasing adhesive force of the ceramic film to the surface of the glass substrate. Thus, surface strength of the glass structure can be enhanced.

According to the aforementioned embodiments, still another advantage of the present invention is that surface strength of the glass structure can be effectively enhanced, so that the glass structure can be used as a protective cover of a touch screen. Therefore, difficulty of a process for fabricating the touch screen can be greatly reduced, and process yield can be increased, thereby decreasing cost of the substrate and the process.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the method and the apparatus of the present invention without departing from the scope or spirit of the invention. In view of the foregoing, it is intended that the present invention cover modifications and variations of this invention provided they fall within the scope of the following claims.

What is claimed is:

1. A method for manufacturing a glass structure, comprising:
providing a glass substrate;
forming a ceramic precursor layer to cover a surface of the glass substrate; and
performing a laser annealing treatment on the ceramic precursor layer to crystallize the ceramic precursor layer into a ceramic film.

2. The method of claim 1, further comprising performing a plasma treatment on the surface of the glass substrate to clean a plurality of capillary pores of the surface of the glass substrate before the ceramic precursor layer is coated on the surface of the glass substrate.

3. The method of claim 2, wherein the operation of forming the ceramic precursor layer comprises infiltrating the ceramic precursor layer into the capillary pores.

4. The method of claim 1, wherein the operation of forming the ceramic precursor layer is performed using a spray coating method, a dip coating method or an inkjet printing method.

5. The method of claim 1, wherein the operation of forming the ceramic precursor layer comprises forming the ceramic precursor layer from metal, metal oxide, metal oxycarbide, metal carbide and/or a mixture thereof.

6. The method of claim 1, wherein the operation of forming the ceramic precursor layer is performed to form the ceramic precursor layer comprising a major component and a minor component, wherein the major component comprises silicon oxide, aluminum oxide, calcium oxide and/or magnesium oxide, and the minor component comprises iron, titanium, manganese, lead or a rare earth element.

7. The method of claim 1, wherein the operation of forming the ceramic precursor layer comprises performing a plurality of operations, each of the operation is performed to form a dense ceramic precursor film, and each of the operation of forming the dense ceramic precursor film comprises:
forming a ceramic precursor film; and
performing a pre-baking treatment on the ceramic precursor film to form the dense ceramic precursor film.

8. An apparatus for manufacturing a glass structure, comprising:
a conveyer suitable to convey a glass substrate:
a coating device disposed above the conveyer and suitable to form a ceramic precursor layer on a surface of the glass substrate; and
a laser annealing device disposed above the conveyer and suitable to perform a laser annealing treatment on the ceramic precursor layer on the surface of the glass substrate.

9. The apparatus of claim 8, further comprising a plasma device disposed above the conveyer and suitable to perform a plasma treatment on the surface of the glass substrate before the ceramic precursor layer is coated on the surface of the glass substrate.

10. The apparatus of claim 8, wherein the coating device comprises:
a coating unit suitable to coat a ceramic precursor film on the surface of the glass substrate; and
a baking unit suitable to perform a pre-baking treatment on the ceramic precursor film.
